(19) United States
(12) Patent Application Publication
(10) Pub. No.: US 2026/0099726 A1
(43) Pub. Date: Apr. 9, 2026

(54) METHOD, APPARATUS, DEVICE AND MEDIUM FOR INFORMATION CLASSIFICATION

(71) Applicants: Lemon Inc., Grand Cayman (KY); Beijing Youzhuju Network Technology Co., Ltd., Beijing (CN)

(72) Inventors: Song BAI, Singapore (SG); Yujun SHI, Singapore (SG); Wenqing ZHANG, Beijing (CN); Bin LU, Los Angeles, CA (US)

(21) Appl. No.: 19/099,724

(22) PCT Filed: Jul. 7, 2023
(86) PCT No.: PCT/CN2023/106315

§ 371 Date: Jan. 29, 2025

(30) Foreign Application Priority Data
Jul. 29, 2022 (CN) 202210908782.3

(51) Int. Cl. G06N 3/098

(52) U.S. Cl. CPC G06N 3/098

(57) ABSTRACT

The embodiment of the disclosure provides an information classification method, apparatus, device and medium. The method includes: training a local classification model at least according to a first training objective, to reduce an association between a plurality of feature representations of information samples generated by the local classification model; and sending a model parameter of the trained local classification model to a remote device, to construct a global classification model for implementing the information classification. By applying decorrelation on the feature representation generated by the model, the problem of dimensional collapse of feature representation is effectively and efficiently solved.

### CROSS REFERENCE TO RELATED APPLICATION

This application is a national stage application based on International Patent Application No. PCT/CN2023/106315, filed Jul. 7, 2023, which claims priority to Chinese Patent Application No. 202210908782.3, filed on Jul. 29, 2022, entitled “Method, Apparatus, Device and Medium for Information Classification”, the disclosures of which are incorporated herein by reference in their entireties.

### FIELD

Example embodiments of the disclosure generally relate to the field of computers, and in particular, to a method, apparatus, device and computer readable storage medium for information classification.

### BACKGROUND

Current machine learning has been widely used, and its performance usually increases with increasing data volume. With the increasing attention of data privacy protection, federated learning has emerged. Federated learning adopts a distributed training manner to support collaborative training across different clients without sharing data. In the federated learning process, the client locally trains the model, and then sends the trained local model related information to the centralized server. The centralized server aggregates model trained at each client based on the information to obtain a global model. In this way, the client does not need to upload the local data to the server, thereby protecting the privacy of the user.

One major challenge in federated learning is the potential discrepancies in the local training data among clients. Such discrepancies can result in disagreements between local optimum of each client and the desired global optimum, which leads to severe performance degradation of the global model.

### SUMMARY

In a first aspect of the present disclosure, a method for information classification is provided. The method comprises: training a local classification model at least according to a first training objective, to reduce an association between a plurality of feature representations of information samples generated by the local classification model; and sending a model parameter of the trained local classification model to a remote device, to construct a global classification model for implementing the information classification.

In a first aspect of the present disclosure, an apparatus for information classification is provided. The apparatus comprises: a training module configured to train a local classification model at least according to a first training objective, to reduce an association between a plurality of feature representations of information samples generated by the local classification model; and a sending module configured to send a model parameter of the trained local classification model to a remote device, to construct a global classification model for implementing information classification.

In a third aspect of the present disclosure, an electronic device is provided. The device comprises: at least one processing unit; and at least one memory coupled to the at least one processing unit and storing instructions for execution by the at least one processing unit. The instructions, when executed by the at least one processing unit, causes the device to perform the method according to the first aspect.

In a fourth aspect of the present disclosure, a computer-readable storage medium is provided. The medium has a computer program stored thereon, the program is executed by a processor to implement the method according to the first aspect.

It should be understood that the content described in the content part of the present disclosure is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be applied;

FIG. 2 shows a flowchart of a process for information classification according to some embodiments of the present disclosure:

FIG. 3 illustrates a block diagram of an apparatus for information classification according to some embodiments of the present disclosure; and

FIG. 4 illustrates a block diagram of a device capable of implementing various embodiments of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

The terms “comprise” and its variants used herein are to be read as open terms that mean “include, but is not limited to.” The term “based on” is to be read as “based at least in part on.” The term “one embodiment” or “this embodiment” is to be read as “at least one embodiment”, and the term “some embodiments” is to be read as “at least some embodiments.” Other definitions, explicit and implicit, might be included below.

It may be understood that the data involved in the technical solution (including but not limited to the data itself, the obtaining, using, storing or deleting of the data) should follow the requirements of the corresponding laws and regulations and related regulations.

It can be understood that before using the technical solutions disclosed in the embodiments of the present disclosure, relevant user should be informed of the types, use ranges, usage scenarios, and the like of the information related to the present disclosure in an appropriate manner according to relevant laws and regulations, and the authorization of the related user may be obtained.

For example, in response to receiving an active request from a user, prompt information is sent to the user to explicitly prompt the user that the requested operation will need to acquire and use the personal information of the user. Therefore, the user may autonomously select whether to provide personal information to software or hardware executing the operation of the technical solution of the present disclosure according to the prompt information, such as an electronic device, application program or storage medium.

As an optional but non-limiting implementation, in response to receiving the active request of the user, the manner of sending the prompt information to the user may be, for example, a pop-up window, and the prompt information may be presented in text in the pop-up window. In addition, the pop-up window may further carry a selection control for the user to select “agree” or “disagree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

As used herein, the term “model” may learn associations between respective inputs and outputs from training data, such that corresponding outputs may be generated for a given input after training is complete. The generation of the model may be based on machine learning techniques. Deep learning is a machine learning algorithm that processes inputs and provides corresponding outputs by using a multi-layer processing unit. The neural network model is one example of a deep learning-based model. As used herein, a “model” may also be referred to as a “machine learning model,” a “learning model,” a “machine learning network,” or a “learning network,” which terms are used interchangeably herein.

A “neural network” is a deep learning-based machine learning network. The neural network is capable of processing inputs and providing corresponding outputs, which typically include an input layer and an output layer and one or more hidden layers between the input layer and the output layer. The neural networks used in deep learning applications typically include many hidden layers, increasing the depth of the network. Each layer of the neural network is connected in sequence, such that the output of the previous layer is provided as an input to the next layer, wherein the input layer receives the input of the neural network and the output of the output layer serves as the final output of the neural network. Each layer of the neural network includes one or more nodes (also referred to as processing nodes or neurons), and each node processes input from the previous layer.

Generally, machine learning may generally include three stages, i.e., a training stage, a testing stage, and an application stage (also referred to as an inference stage). At the training stage, a given model may be trained using a large amount of training data, iteratively updating parameter values until the model can obtain consistent inference that meets the expected objectives from the training data. By training, the model may be considered to be able to learn from the training data an association from input to output (also referred to as mapping of input to output). The parameter values of the trained model are determined. In the testing stage, the test input is applied to the trained model to test whether the model can provide correct output, thereby determining the performance of the model. In the application stage, the model may be used to process the actual input based on the parameter value obtained by training to determine a corresponding output.

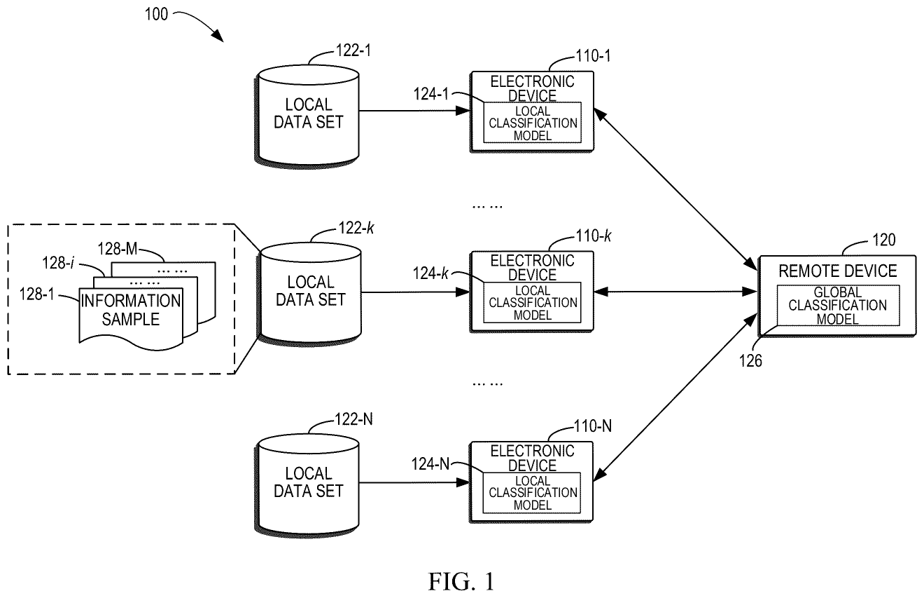

FIG. 1 illustrates a schematic diagram of an example environment 100 in which embodiments of the present disclosure can be implemented.

The environment 100 is adapted to perform federated learning, including N electronic devices 110-1 . . . 110-k, . . . 110-N (N is an integer greater than 1, k=1, 2, . . . N) and a remote device 120. In the federated learning process, the N electronic devices 110-1 . . . 110-k, . . . 110-N may act as client node for performing the local training process of federated learning. The remote device 120 may act as a central node for aggregating the training results of the client nodes. For case of discussion, the electronic devices 110-1 . . . 110-k, . . . 110-N can be collectively or individually referred to as electronic devices 110.

In some embodiments, the electronic device 110 may be implemented at the terminal device. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a gaming device, or any combination of the foregoing, including accessories and peripherals of these devices, or any combination thereof. In some embodiments, the terminal device can also support any type of interface for a user (such as a “wearable” circuit, etc.).

The remote device 120 may be implemented at a server. The server may be various types of computing system/server capable of providing computing capability, including, but not limited to, mainframes, edge computing nodes, computing devices in a cloud environment, and the like.

In some other embodiments, one or more of the electronic devices 110-1 . . . 110-k, . . . 110-N may be implemented at a server, while the remote device 120 may be implemented at a terminal device. Alternatively, the electronic device 110 and the remote device 120 may both be implemented at the terminal device or at the server. In some applications, the remote device 120 may serve as a client node in addition to serving as a central node for local model training, performance evaluation, and the like.

In the example of FIG. 1, the electronic devices 110-1 . . . 110-k, . . . 110-N respectively maintain respective local datasets 122-1 . . . 122-k, . . . 122-N (individually or collectively as local datasets 122) for training the local classification models 124-1 . . . 124-k, . . . 124-N (individually or collectively as local classification model). The model parameters of the trained local classification models 124-1 . . . 124-k, . . . 124-N are respectively sent by the electronic devices 110-1 . . . 110-k, . . . 110-N to the remote device 120 for the remote device 120 to construct the global classification model 126.

The local classification model 124 and the global classification model 126 may be constructed based on various model architectures based on machine learning or deep learning, and may be configured to implement various classification tasks, such as image classification, text classification, audio classification, etc., for application scenarios such as image recognition, text recognition, audio recognition, and the like.

The local dataset 122 at the electronic device 110 may comprise information samples. FIG. 1 schematically shows that the local dataset 122-k at the electronic device 110-k includes a plurality of (M) information samples 128-1, 128-i, . . . 128-M (individually or collectively as information samples 128), where M is an integer greater than 1, i=1, 2, . . . . M.

Information samples 128 may comprise input information related to specific tasks of classification models 124 and 126. For example, where the classification models 124 and 126 are applied to image recognition, text recognition, or audio recognition, the information samples 128 may comprise image samples, text samples, or audio samples accordingly. As an example, in an image classification task, the classification models 124 and 126 may be configured to classify the input image samples into one of a plurality of categories.

In fact, many applications may be classified as binary classification tasks, where the input information is classified into one of two categories. For example, in an information recommendation scenario, input information may be classified as one of two categories “recommended” and “not recommended”. The information classification described herein may be used in any suitable application scenario.

In the training stage of the local classification model 124, the electronic device 110 may perform local training based on the respective local datasets 122. However, the training data in each local data set 122 tends to be quite different. This data discrepancies is also referred to as data heterogeneity (or heterogencity), which leads to a decrease in the performance of the global classification model 126.

Existing solutions are mainly focused on optimization of model parameter in local training and global aggregation processes. However, these solutions introduce very large computational burden and/or communication overhead due to over-parameterization of the deep neural network.

The inventors have noted that in a heterogeneous federated learning environment, a locally trained model may cause dimensional collapse. The feature representation of the input information generated using the local model is often only present in the low-dimensional subspace rather than the complete feature representation space. In addition, by applying singular value decomposition on the covariance matrix of the feature representation vector outputted by the local model, the inventor finds that more singular values approach zero as the degree of heterogencity of data increases. That is, the larger the degree of data heterogeneity, the more serious the dimensional collapse.

To this end, embodiments of the present disclosure provide an optimization solution for federated learning, which can prevent a feature representation dimensional collapse, thereby improving performance. According to this solution, a training objective (referred to as a “first training objective”) for reducing an association between a plurality of feature representations of information samples generated by a model is added in a training process of the local classification model. The model parameters of the trained local classification model are sent to the remote device for constructing a global classification model to implement information classification.

According to the scheme, decorrelation is performed on the feature representation generated by the model, and the problem of feature representation dimensional collapses is effectively solved. Moreover, the solution is simple and feasible, and does not introduce excessive computational burden and unnecessary communication overhead.

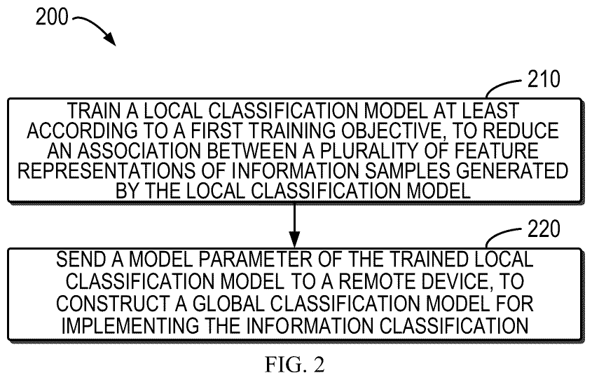

FIG. 2 shows a flowchart of a process 200 for information classification according to some embodiments of the present disclosure. The process 200 may be implemented at electronic device 110. For case of discussion, the process 200 will be described in conjunction with the environment 100 of FIG. 1.

At block 210, a local classification model (e.g., local classification model 124 in FIG. 1) is trained at least according to the first training objective, to reduce an association between the plurality of feature representations of information samples (e.g., information samples 128 in the figure) generated by the local classification model. These feature representations may be extracted from one or a batch of information samples, may have any suitable form capable of representing respective information samples. The number of information samples represented by these feature representations may be determined according to actual needs. By reducing the association between the generated feature representations, the problem of feature representation dimensional collapse can be effectively alleviated.

The association between feature representations may be reduced by any suitable means. In some embodiments, the feature representation vector composed of the plurality of feature representations may be normalization first, for example, as shown in equation (1) below:

$${\hat{z}}_{i} = ( {z}_{i} - \overline{z} ) / \sqrt{Var ( z )} \qquad ( 1 )$$

Wherein, \hat{z}ᵢ Represents the normalized feature representation vector, zᵢ represents the i-th feature representation vector, z̅ represents the mean value of the feature representation vector, and Var(z) represents the variance of the feature representation vector. In turn, a correlation matrix of the normalized feature representation vectors may be generated.

The generated correlation matrix may be utilized to train the local classification model to reduce the association between the feature representations, thus to satisfy the first training objective. In some embodiments, the association between the feature representations may be reduced by decreasing the values of the non-diagonal elements of the correlation matrix. Through the normalization operation, the correlation matrix of the feature representation vector may be equivalent to its covariance matrix. The local classification model is trained based on the correlation matrix, so that the association between the feature representations can be further reduced, and the dimensional collapse of the feature representation is further effectively relieved.

The association between feature representations may also be reduced with correlation matrices by other means. In some embodiments, the value of the Frobenius norm of the correlation matrix may be calculated, and the local classification model is trained by decreasing the value of the Frobenius norm. The smaller the value of Frobenius norm, the lower the association between the feature representations, thereby effectively mitigating the dimensional collapse of the feature representations.

In some embodiments, a loss function or a cost function may also be constructed based on the correlation matrix to cause the local classification model to reach the first training objective. Equation (2) below shows the loss function L_{FedDeclar} constructed based on Frobenius norm:

$${{L}_{FedDecorr} ( w , X ) = \frac{1}{{d}^{2}} \vert \vert K ‖}_{F}^{2} \qquad ( 2 )$$

Where, [symbol] represents a model parameter, X represents a batch of information samples, d represents a dimension of the feature representation vector, K represents a correlation matrix of the feature representation vector, and

$${‖ \cdot ‖}_{F}^{2} )$$

represents a Frobenius norm.

In equation (2), the smaller the value of Frobenius norm, the smaller the value of the loss function. By taking the value of the loss function smaller and smaller until a convergence condition is reached, the local classification model may be trained. The convergence condition may be, for example, minimization of losses resulting from a loss function, e.g., equal to zero or equal to other acceptable values.

In some embodiments, the loss function may also be constructed by summing the squares of each element in the correlation matrix and then taking the average instead of the Frobenius norm. The local classification model is trained based on the loss function, and the association of the feature representation can be effectively reduced, thereby preventing the feature representation dimensional collapse.

In some embodiments, in the training process of the local classification model, in addition to considering the first training objective, a training objective (referred to as “second training objective”) for improving consistency between the target category of the information sample determined by the local classification model and the reference category of the information sample may be considered. The reference category of the information sample may be stored as a label with the information sample in a local dataset.

In some embodiments, a cross-entropy loss function may be used to evaluate the consistency between the target category and the reference category of the information sample. The use of other algorithms or other forms of loss functions are possible, and the scope of the present disclosure is not limited in this respect.

In some embodiments, both the first training objective and the second training objective may be taken together as a training objective of the local classification model. Equation (3) below shows a loss function constructed simultaneously considering both the first training objective and the second training objective:

$${min}_{w} ℓ ( w , X , y ) + β {L}_{FedDecorr} ( w , X ) \qquad ( 3 )$$

Where, [symbol] represents a cross-entropy loss function, β represents an adjustment coefficient of L_{FedDeclar}, and y represents a label. In formula (3), the first training objective is used as an adjustment term of the second training objective. Training the local classification model based on the loss function shown in equation (3) may simultaneously satisfy the two training objectives.

After training the local classification model, at block 220, the model parameters of the trained local classification model are sent to a remote device (e.g., remote device 120 in FIG. 1) for constructing a global classification model (e.g., global classification model 126 in FIG. 1) that implements the information classification. By utilizing the scheme according to the embodiment of the disclosure, the performance of the global classification model can be remarkably improved, meanwhile, only very few calculation overheads are added by the scheme, thus the calculation efficiency is not influenced.

The federated learning optimization scheme (denoted as FedDecorr) according to embodiments of the present disclosure has a significant improvement over other approaches (e.g., FedAvg, FeeProx, FedAvgM, MOON, etc.) in simulation using CIFAR10, CIFAR100, TinyImagNet datasets for image recognition. Performance comparison between the solutions of the present disclosure and other methods is discussed below with reference to Table 1 to Table 4.

Reference is firstly made to Table 1, which shows an image recognition accuracy comparison using or not using the solutions of the present disclosure in the case of simulation with datasets CIFAR10 and CIFAR100.

TABLE 1

| | CIFAR10 | | | | CIFAR100 | | | |
|---|---|---|---|---|---|---|---|---|
| Method | α = 0.05 | 0.1 | 0.5 | ∞ | 0.05 | 0.1 | 0.5 | ∞ |
| FedAvg [23] | 64.85 ± 2.01 | 76.28 ± 1.22 | 89.84 ± 0.13 | 92.39 ± 0.2 [symbol] | 59.87 ± 0. [symbol] | 66.46 ± 0. [symbol] | 71.69 ± 0. [symbol] | 74.54 ± 0. [symbol] |
| +FEDDECORR | 73.06 ± 0.8 [symbol] | 80.60 ± 0. [symbol] | 89.84 ± 0.05 | 91.19 ± 0. [symbol] | 61.53 ± 0. [symbol] | 67.12 ± 0. [symbol] | 71.91 ± 0.0 [symbol] | 73.87 ± 0. [symbol] |
| FedProx [20] | 64.11 ± 0.84 | 76.10 ± 0.40 | 89.57 ± 0. [symbol] | 92.38 ± 0.09 | 60.02 ± 0.4 [symbol] | 66.41 ± 0. [symbol] 7 | 71.78 ± 0. [symbol] | 74.34 ± 0. [symbol] |
| +FEDDECORR | 71.38 ± 0. [symbol] | 81.74 ± 0.3 [symbol] | 89.96 ± 0.2 [symbol] | 92.14 ± 0. [symbol] | 61.33 ± 0. [symbol] 9 | 67.00 ± 0. [symbol] | 71.64 ± 0. [symbol] | 74.15 ± 0. [symbol] |
| FedAvgM [11] | 71.34 ± 0. [symbol] | 77.51 ± 0. [symbol] | 88.39 ± 0.17 | 91.35 ± 0. [symbol] | 59.64 ± 0.20 | 66.36 ± 0. [symbol] | 71.17 ± 0. [symbol] | 74.20 ± 0. [symbol] |
| +FEDDECORR | 73.60 ± 0.82 | 79.21 ± 0.. [symbol] | 88.70 ± 0. [symbol] | 91.33 ± 0. [symbol] | 61.48 ± 0. [symbol] | 66.60 ± 0. [symbol] | 71.26 ± 0. [symbol] | 73.86 ± 0. [symbol] |
| MOON [18] | 68.79 ± 0.69 | 78.70 ± 0.66 | 90.08 ± 0. [symbol] | 92.62 ± 0. [symbol] | 56.79 ± 0. [symbol] | 65.48 ± 0. [symbol] | 71.81 ± 0. [symbol] | 74.30 ± 0. [symbol] |
| +FEDDECORR | 73.46 ± 0.84 | 81.63 ± 0. [symbol] | 90.61 ± 0. [symbol] | 92.63 ± 0. [symbol] 9 | 59.43 ± 0. [symbol] | 66.12 ± 0. [symbol] | 71.68 ± 0. [symbol] | 73.70 ± 0. [symbol] |

[symbol]

indicates data missing or illegible when filed

Wherein, α∈{0.05, 0.1, 0.5, ∞} indicates the degree of heterogeneity, the smaller α is, the greater the degree of heterogeneity is. As shown in Table 1, after the solution of the present disclosure is adopted, the accuracy of image recognition is significantly improved.

Table 2 shows the image recognition accuracy comparison using or not using the solutions of the present disclosure in the case of simulation with the dataset TinyImageNet.

TABLE 2

| | TinyImageNet | | | |
|---|---|---|---|---|
| Method | α = 0.05 | 0.1 | 0.5 | ∞ |
| FedAvg [23] | 35.02_{±0.46} | 39.30_{±0.23} | 46.92_{±0.25} | 49.33_{±0.19} |
| +FEDDECORR | 40.29_{±0.18} | 43.86_{±0.30} | 50.01_{±0.27} | 52.63_{±0.26} |
| FedProx [20] | 35.20_{±0.30} | 39.66_{±0.43} | 47.16_{±0.07} | 49.76_{±0.36} |
| +FEDDECORR | 40.63_{±0.05} | 44.19_{±0.14} | 50.26_{±0.27} | 52.37_{±0.36} |
| FedAvgM [11] | 34.81_{±0.09} | 39.72_{±0.11} | 47.11_{±0.04} | 49.67_{±0.25} |
| +FEDDECORR | 39.97_{±0.23} | 43.95_{±0.26} | 50.14_{±0.11} | 52.05_{±0.37} |
| MOON [18] | 35.23_{±0.26} | 40.53_{±0.28} | 47.25_{±0.66} | 50.48_{±0.57} |
| +FEDDECORR | 40.40_{±0.24} | 44.20_{±0.22} | 50.81_{±0.51} | 53.01_{±0.45} |

As shown in Table 2, the accuracy of image recognition with the solution of this disclosure is remarkably improved compared without the solution of this disclosure.

Table 3 shows that when the number of clients is different, the accuracy of image recognition according to the solutions of the present disclosure is compared.

TABLE 3

| # clients | Method | α = 0.05 | 0.1 | 0.5 |
|---|---|---|---|---|
| 10 | FedAvg | 35.02 | 39.30 | 46.92 |
| | +FEDDECORR | 40.29 | 43.86 | 50.01 |
| 20 | FedAvg | 31.21 | 35.30 | 43.64 |
| | +FEDDECORR | 39.41 | 41.27 | 46.17 |
| 30 | FedAvg | 26.20 | 30.88 | 37.22 |
| | +FEDDECORR | 36.50 | 39.02 | 44.38 |
| 40 | FedAvg | 24.10 | 27.19 | 32.75 |
| | +FEDDECORR | 34.14 | 36.81 | 39.60 |

As shown in Table 3, regardless of the number of clients, the accuracy of image recognition is significantly improved after the solutions of the present disclosure are used.

Table 4 shows the calculation time comparison of the solution of the present disclosure with other methods.

TABLE 4

| | CIFAR10 | CIFAR100 | TinyImageNet |
|---|---|---|---|
| FedAvg | 6.7 | 6.9 | 25.4 |
| FedProx | 12.1 | 12.3 | 33.2 |
| MOON | 12.2 | 12.7 | 38.1 |
| FEDDECORR | 6.9 | 7.1 | 25.7 |

As shown in Table 4, the solution of the present disclosure is obviously shortened in calculation time and high in calculation efficiency compared with other method. Compared with other methods, the solution of the present disclosure only results in negligible computation overhead.

As the degree of current data heterogeneity tends to be aggravated, and the number of clients tends to increase, the federated learning environment becomes more challenging. The adoption of the scheme according to the embodiment of the disclosure can bring more performance improvement.

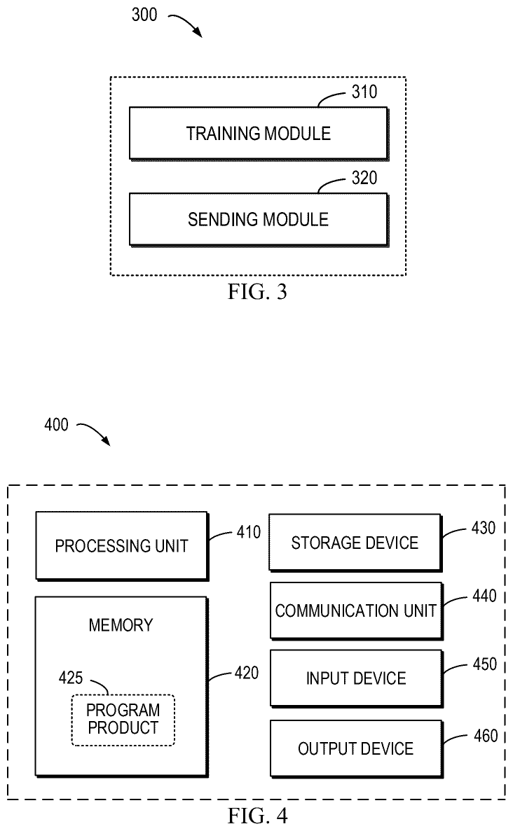

FIG. 3 shows a schematic structural block diagram of an apparatus 300 for information classification according to some embodiments of the present disclosure. The apparatus 300 may be implemented or included in the electronic device 110. The various modules/components in the apparatus 300 may be implemented by hardware, software, firmware, or any combination thereof.

As shown in FIG. 3, the apparatus 300 comprises a training module 310 and a sending module 320. The training module 310 is configured to train a local classification model at least according to a first training objective, to reduce an association between a plurality of feature representations of information samples generated by the local classification model. The sending module 320 is configured to send a model parameter of the trained local classification model to a remote device, to construct a global classification model for implementing the information classification.

In some embodiments, the plurality of feature representations constitute a feature representation vector. The training module 310 is further configured to: normalize the feature representation vector; generate a correlation matrix of the normalized feature representation vectors; and train the local classification model based on the correlation matrix to meet the first training objective.

In some embodiments, the training module 310 is further configured to: train the local classification model by decreasing a value of a non-diagonal element of the correlation matrix.

In some embodiments, the training module 310 is further configured to: calculate a value of Frobenius norm of the correlation matrix; and train the local classification model by decreasing the value of the Frobenius norm.

In some embodiments, the training module 310 is further configured to: determine, by using the local classification model, a target category of the information sample based on the plurality of feature representations; and train the local classification model further according to a second training objective, to increase consistency between the target category and a reference category of the information sample.

In some embodiments, the training module 310 is further configured to: evaluate consistency between the target category and the reference category using a cross-entropy loss function; and train the local classification model by increasing the consistency to satisfy the second training objective.

In some embodiments, the information comprises at least one of an image, text, or audio. The global classification model is used for at least one of image recognition, text recognition, or audio recognition.

It should be understood that the features and effects related to the process 200 discussed above with reference to FIG. 1 and FIG. 2 are also applicable to the apparatus 300, and details are not repeated here. In addition, the modules included in the apparatus 300 may be implemented in various manners, including software, hardware, firmware, or any combination thereof. In some embodiments, one or more modules may be implemented using software and/or firmware, such as machine-executable instructions stored on a storage medium. In addition to or as an alternative to machine-executable instructions, some or all of the modules in the apparatus 300 may be implemented, at least in part, by one or more hardware logic components. By way of example and not limitation, exemplary types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 4 is a block diagram illustrating an electronic device 400 in which one or more embodiments of the present disclosure may be implemented. It should be understood that the electronic device 400 illustrated in FIG. 4 is merely exemplary and should not constitute any limitation on the functionality and scope of the embodiments described herein. The electronic device 400 shown in FIG. 4 may be configured to implement the electronic device 110 in FIG. 1.

As shown in FIG. 4, the electronic device 400 is in the form of a general-purpose computing device. Components of the electronic device 400 may include, but are not limited to, one or more processors or processing units 410, a memory 420, a storage device 430, one or more communication units 440, one or more input devices 450, and one or more output devices 460. The processing unit 410 may be an actual or virtual processor and capable of performing various processes according to programs stored in the memory 420. In multiprocessor system, multiple processing units execute computer-executable instructions in parallel to improve parallel processing capabilities of electronic device 400.

The electronic device 400 typically comprises a plurality of computer storage media. Such media may be any available media accessible to the electronic device 400, including, but not limited to, volatile and non-volatile media, removable and non-removable media. The memory 420 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 430 may be a removable or non-removable medium and may include a machine-readable medium, such as a flash drive, magnetic disk, or any other medium, which may be capable of storing information and/or data (e.g., training data for training) and may be accessed within electronic device 400.

The electronic device 400 may further include additional removable/non-removable, volatile/non-volatile storage media. Although not shown in FIG. 4, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interface. The memory 420 may include a computer program product 425 having one or more program modules configured to perform various methods or actions of various embodiments of the present disclosure.

The communications unit 440 implements communications with other computing devices over a communications medium. Additionally, the functionality of components of the electronic device 400 may be implemented in a single computing cluster or multiple computing machines capable of communicating over a communication connection. Thus, the electronic device 400 may operate in a networked environment using logical connections with one or more other servers, network personal computers (PCs), or another network Node.

The input device 450 may be one or more input devices, such as a mouse, a keyboard, a trackball, or the like. The output device 460 may be one or more output devices, such as a display, a speaker, a printer, or the like. The electronic device 400 may also communicate with one or more external devices (not shown) through the communication unit 440 as needed, external devices such as storage devices, display devices, etc., communicate with one or more devices that enable a user to interact with the electronic device 400, or communicate with any device (e.g., network card, modem, etc.) that enables the electronic device 400 to communicate with one or more other computing devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1-16. (canceled)

17. A method for information classification, comprising:
training a local classification model, at least according to a first training objective, to reduce an association between a plurality of feature representations of information samples generated by the local classification model; and
sending a model parameter of the trained local classification model to a remote device to construct a global classification model for implementing the information classification.

18. The method of claim 17, wherein the plurality of feature representations constitute a feature representation vector, wherein training the local classification model comprises:
normalizing the feature representation vector;
generating a correlation matrix of the normalized feature representation vectors; and
training the local classification model based on the correlation matrix to meet the first training objective.

19. The method of claim 18, wherein training the local classification model based on the correlation matrix comprises:
training the local classification model by decreasing a value of a non-diagonal element of the correlation matrix.

20. The method of claim 18, wherein training the local classification model based on the correlation matrix comprises:
calculating a value of Frobenius norm of the correlation matrix; and
training the local classification model by decreasing the value of the Frobenius norm.

21. The method of claim 17, wherein training the local classification model comprises:
determining, by using the local classification model, a target category of the information sample based on the plurality of feature representations; and
training the local classification model further according to a second training objective to increase consistency between the target category and a reference category of the information sample.

22. The method of claim 21, wherein training the local classification model further according to the second training objective comprises:
evaluating consistency between the target category and the reference category using a cross-entropy loss function; and
training the local classification model by increasing the consistency to satisfy the second training objective.

23. The method of claim 17, wherein:
the information comprises at least one of an image, text, or audio; and
the global classification model is used for at least one of image recognition, text recognition, or audio recognition.

24. An electronic device, comprising:
at least one processing unit; and
at least one memory coupled to the at least one processing unit and storing instructions for execution by the at least one processing unit, the instructions, when executed by the at least one processing unit, causing the device to perform operations comprising:
training a local classification model, at least according to a first training objective, to reduce an association between a plurality of feature representations of information samples generated by the local classification model; and
sending a model parameter of the trained local classification model to a remote device to construct a global classification model for implementing the information classification.

25. The electronic device of claim 24, wherein the plurality of feature representations constitute a feature representation vector, wherein training the local classification model comprises:
normalizing the feature representation vector;
generating a correlation matrix of the normalized feature representation vectors; and
training the local classification model based on the correlation matrix to meet the first training objective.

26. The electronic device of claim 25, wherein training the local classification model based on the correlation matrix comprises:
training the local classification model by decreasing a value of a non-diagonal element of the correlation matrix.

27. The electronic device of claim 25, wherein training the local classification model based on the correlation matrix comprises:
calculating a value of Frobenius norm of the correlation matrix; and
training the local classification model by decreasing the value of the Frobenius norm.

28. The electronic device of claim 24, wherein training the local classification model comprises:
determining, by using the local classification model, a target category of the information sample based on the plurality of feature representations; and
training the local classification model further according to a second training objective to increase consistency between the target category and a reference category of the information sample.

29. The electronic device of claim 28, wherein training the local classification model further according to the second training objective comprises:
evaluating consistency between the target category and the reference category using a cross-entropy loss function; and
training the local classification model by increasing the consistency to satisfy the second training objective.

30. The electronic device of claim 24, wherein:
the information comprises at least one of an image, text, or audio; and
the global classification model is used for at least one of image recognition, text recognition, or audio recognition.

31. A non-transitory computer-readable storage medium having a computer program stored thereon, the computer program being executed by a processor to implement operations comprising:
training a local classification model, at least according to a first training objective, to reduce an association between a plurality of feature representations of information samples generated by the local classification model; and
sending a model parameter of the trained local classification model to a remote device to construct a global classification model for implementing the information classification.

32. The non-transitory computer-readable storage medium of claim 31, wherein the plurality of feature representations constitute a feature representation vector, wherein training the local classification model comprises:
normalizing the feature representation vector;
generating a correlation matrix of the normalized feature representation vectors; and
training the local classification model based on the correlation matrix to meet the first training objective.

33. The non-transitory computer-readable storage medium of claim 32, wherein training the local classification model based on the correlation matrix comprises:
training the local classification model by decreasing a value of a non-diagonal element of the correlation matrix.

34. The non-transitory computer-readable storage medium of claim 32, wherein training the local classification model based on the correlation matrix comprises:
calculating a value of Frobenius norm of the correlation matrix; and
training the local classification model by decreasing the value of the Frobenius norm.

35. The non-transitory computer-readable storage medium of claim 31, wherein training the local classification model comprises:
determining, by using the local classification model, a target category of the information sample based on the plurality of feature representations; and
training the local classification model further according to a second training objective, to increase consistency between the target category and a reference category of the information sample.

36. The non-transitory computer-readable storage medium of claim 35, wherein training the local classification model further according to the second training objective comprises:
evaluating consistency between the target category and the reference category using a cross-entropy loss function; and
training the local classification model by increasing the consistency to satisfy the second training objective.
